(19) United States
(12) Patent Application Publication
(10) Pub. No.: US 2009/0241426 A1
(43) Pub. Date: Oct. 1, 2009

(54) VERTICAL DROP VEHICLE SLIDER ASSEMBLY

(75) Inventors: Shane C. Seiple, Perrysburg, OH (US); Charles E. Ash, Perrysburg, OH (US); H. Richard Voght, Perrysburg, OH (US)

Correspondence Address: MARSHALL & MELHORN, LLC, FOUR SEAGATE - EIGHTH FLOOR, TOLEDO, OH, 43604, US

(73) Assignee: PILKINGTON NORTH AMERICA, INC., TOLEDO, OH (US)

(21) Appl. No.: 12/309,126

(22) PCT Filed: Jul. 9, 2007
(86) PCT No.: PCT/US2007/015279

§ 371 Date: Jan. 6, 2009

(51) Int. Cl. B60J 1/18

(52) U.S. Cl. 49/374

(57) ABSTRACT

A partial and a full drop vertical vehicle slider assembly are provided that do not require a horizontal beltline support member. For the partial drop assembly, two fixed panels each with a division member, an upper header member, and a horizontal vehicle body opening edge abut to form the slider panel opening. For the full drop assembly, an upper header member, two upper slider assembly side members, and a horizontal vehicle body opening edge abut one another to form a slider panel opening. In both cases, the horizontal vehicle body opening edges have seals attached, through which a slider panel vertically slides up and spans the vertical extent of the slider panel opening to close the slider assembly, and slides down into the vehicle body to open the slider panel opening. In the case of the full drop assembly, unimpaired backlite viewing is provided.

### FIELD OF THE INVENTION

The present invention relates to a vertical drop vehicle slider assembly.

### BACKGROUND OF THE INVENTION

It is known that pick-up trucks and other related vehicles have a rear window, or backlite, that is mounted in the vehicle body opening, immediately behind seats in the vehicle passenger compartment. Typically, such backlites are supplied to vehicle manufacturers as a one piece or a stand-alone frame assembly for installation in new vehicles being manufactured on an assembly line.

In some of these vehicles, the backlite is provided with a sliding panel mechanism and seal system (commonly known as a slider), which opens and closes over an opening in the backlite, so as to allow, for example, outside air to enter the vehicle compartment and to allow for the passing of objects through the backlite opening. Sliders, in which a sliding panel moves in a horizontal direction or a vertical direction (also known as a vertical drop slider), comprise at least one sliding panel that, typically, utilizes a pathway, for example, frame channels, rails, or tracks to facilitate sliding motion.

Typically, there is a peripheral frame assembly, with an attached seal(s) that acts to seal out, for example, moisture and noise from entering the vehicle compartment at the periphery surfaces and edges of the backlite at the vehicle body opening. Also typically, there is a backlite opening frame assembly, with attached seals, that acts to seal out moisture and noise from entering the backlite opening when the sliding panel closes the backlite opening (a.k.a. slider panel opening).

It is common for a backlite to be mounted as a free-standing assembly, such as a molded framework assembly with a lower beltline support member, into the vehicle body opening in the vehicle body frame, where the backlite assembly is secured to the vehicle body opening with adhesives and/or mechanical fastening devices, for example, studs. A urethane adhesive is frequently used in backlite applications, such adhesive being applied to a mounting surface of either the vehicle body opening and/or the backlite assembly, prior to the moment at which these two structures are brought into bonding contact. It is also common for the backlite frame assembly to utilize a molded framework with the lower beltline support member.

In addition to the slider panel, some vertical slider assemblies have two fixed panels (hence, they are known as partial sliders), which, typically, are positioned on either side of the backlite opening. In the case of a partial vertical slider, each fixed panel has a substantially vertically oriented panel edge, on which a vertical track and/or division post are often disposed. As a result, viewing through the backlite can be somewhat impaired. Also typically, the backlite opening is further defined by an upper header member and a lower beltline support member.

For the vertical slider, the slider panel is moved in a vertical direction between a space within the vehicle body that is below the vehicle body opening (along the vertical tracks that are commonly rigidly attached to the slider) and then, is moved to cover the backlite opening. Often, this movement of the sliding panel is achieved by an electro-mechanical means.

An example of a partial vertical slider is U.S. Pat. No. 6,223,470 to Millard, who teaches a vertical slider window module having a sliding pane that moves between two fixed panes on vertically oriented division bars that are part of a skeletal framework. The skeletal framework further comprises an upper header member and a lower beltline support member, which are directly attached to the framework. Each division bar is disposed on an edge of a separate fixed pane, spanning the vertical extent of a window aperture, where the division bars rigidly extend into a vehicle body space that is below the window aperture. The skeletal framework, the fixed panes, and the division bars are bonded together by a plastic encapsulation frame, which provides the Millard slider with substantial rigidity/stiffness.

Similarly, U.S. Pat. No. 6,691,494 to Nestell et al. provides a vertical slider assembly having fixed panes and one or more sliding panes, which slide on vertical tracks that are supported by vertical members. The vertical tracks rigidly extend into a vehicle body space that is below a slider opening. A slider frame is provided that includes an upper horizontal header member and a lower horizontal beltline support member, which is directly attached to the frame. The frame is utilized to hold the horizontal members, seals, the fixed panes, the vertical tracks, and the vertical members, so as to provide the slider assembly with substantial rigidity.

On the other hand, U.S. Pat. No. 6,422,638 to Carnaghi et al. discloses a preassembled drop glass unit that has a housing that is rigidly attached to a slider frame. The slider frame includes an upper horizontal header member, a lower horizontal beltline support member, which is directly attached to the slider frame, and vertical frame members that provide sliding tracks for the raising and the lowering of a drop glass window. However, the vertical frame members also rigidly extend into a vehicle body space that is below a slider opening. Various additional horizontal reinforcement members are also provided, to further assure substantial rigidity for the drop glass window. The backlite viewing area is comprised of the drop glass window, left and right fixed windows that may pivot to an open position, and the corresponding left and right frame members. After the housing is inserted into the cab, the slider frame is attached to a peripheral edge of the cab.

In all of these examples, the slider assembly comprises a framework (i.e., frame assembly) having at least an upper header member and a lower beltline support member, which are directly attached to the framework, and vertical track members that rigidly extend into a vehicle body space that is below a slider opening. Also, each of these frameworks is required to be robust so that the corresponding slider assembly attains substantial rigidity/stiffness from the slider assembly itself. Consequently, these slider assemblies are costly and they can be difficult to install in the vehicle body opening.

Hence, a vertical slider assembly is sought that is simpler in design, has fewer parts, is not difficult to install in the vehicle body opening, and does not necessarily attain the required rigidity from the slider assembly itself. Instead, the vertical slider being sought may take advantage of the vehicle body, in order to provide a portion of the required rigidity and seal engagement, when the vertical slider has been installed over a vehicle opening.

Further, a vertical slider assembly is sought that may provide unimpaired viewing through the backlite viewing area, allows for larger items to be passed through the backlite opening, and does not give the impression that the vehicle/backlite has a slider. Instead, a vertical slider is sought that takes advantage of the vehicle body, in order to provide the required rigidity, along with the remaining seal engagement, when the vertical slider has been assembled over a vehicle opening. As a result, such a vertical slider could be lighter in weight, could require less space to store and transport, could have lower material and labor costs, could be easier to install, and could act as a better noise and moisture barrier for the backlite.

### SUMMARY OF THE INVENTION

A vehicle slider assembly is comprised of at least one vertical slider panel adapted for sliding movement between a closed position and an open position over a slider panel opening and a slider panel frame comprised of one or more frame members with a horizontal gap therebetween. The slider panel frame is adapted to be secured within a vehicle body opening and has a channel defined therein for selectively receiving a peripheral edge of the slider panel. The slider panel opening is defined by the one or more frame members and a vehicle body opening edge that coincides with the horizontal gap in the slider panel frame.

Further advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a three dimensional view of a partial drop vertical slider in accordance with the present invention;

FIG. 1a is a three dimensional view of a full drop vertical slider in accordance with the present invention;

FIG. 2 is a rear elevation view of a vehicle body portion with the partial drop vertical slider of FIG. 1, where a partial drop slider panel is in the fully lowered position;

FIG. 2a is a rear elevation view of a vehicle body portion with the full drop vertical slider of FIG. 1a, where a full drop slider panel is in the fully lowered position;

FIG. 3 is the rear elevation view of FIG. 2, where the partial drop slider panel is in the fully raised position;

FIG. 3a is the rear elevation view of FIG. 2a, where the full drop slider panel is in the fully raised position;

FIG. 4a is a cut away view in the direction of the line 4a-4a of FIG. 3;

FIG. 4a′ is a cut away view in the direction of the line 4a′-4a′ of FIG. 3a;

FIG. 4b is a detailed view of the top portion of FIG. 4a;

FIG. 4b′ is a detailed view of the top portion of FIG. 4a′;

FIG. 4c is a detailed view of the middle portion of FIG. 4a;

FIG. 4c′ is a detailed view of the middle portion of FIG. 4a′;

FIG. 5 is a cut away view in the direction of the line 5-5 of FIG. 1;

FIG. 5a is a cut away view in the direction of the line 5′-5′ of FIG. 1a;

FIG. 6a is a cross sectional cut away view in the direction of either of the 6a arrows of FIG. 1, of partial slider vertical rails in a retracted position;

FIG. 6a′ is a cross sectional cut away view in the direction of either of the 6a′ arrows of FIG. 1a, of full slider vertical rails in a retracted position;

FIG. 6b is a cross sectional cut away view in the direction of either of the 6b arrows of FIG. 2, of the partial slider vertical rails in an extended position; and

FIG. 6b′ is a cross sectional cut away view in the direction of either of the 6b′ arrows of FIG. 2a, of the full slider vertical rails in an extended position.

### DETAILED DESCRIPTION OF THE INVENTION

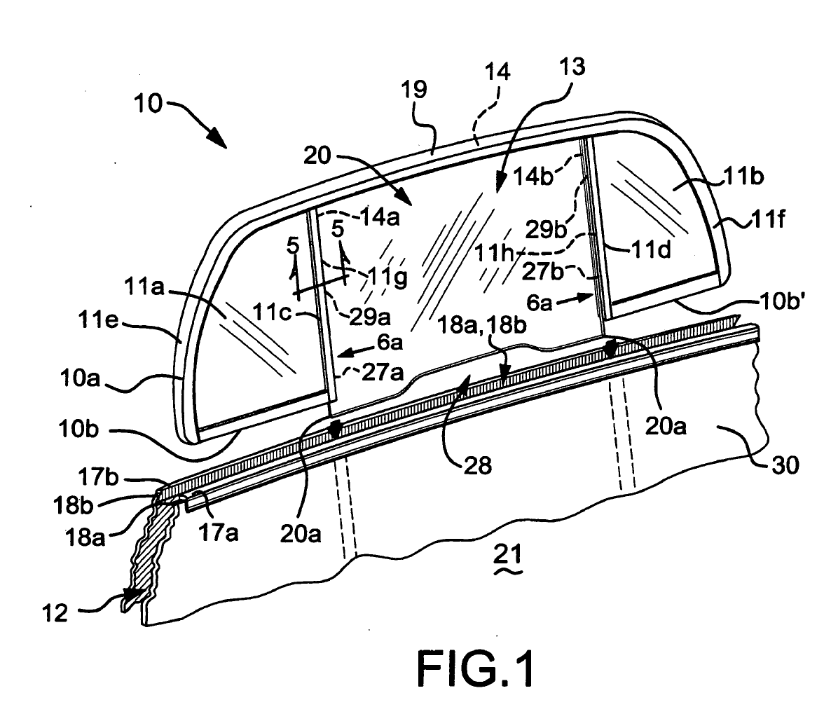

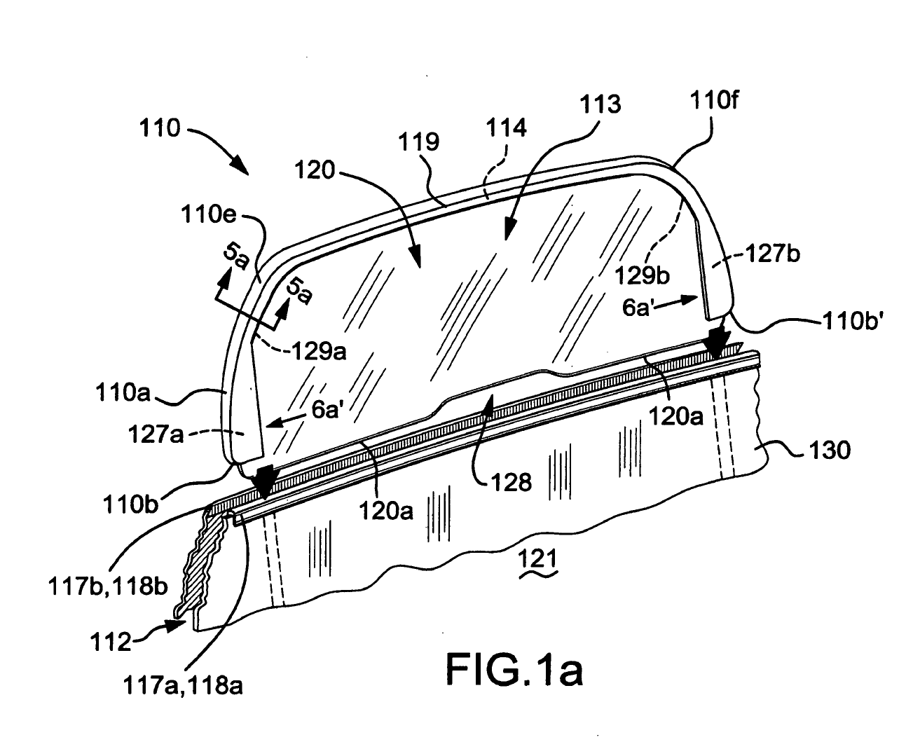

Illustrated in FIG. 1 is an embodiment of a vehicle slider frame assembly that is a partial drop vertical vehicle slider assembly 10 (a.k.a. a backlite with a slider) having at least one vertical sliding panel 20 (a.k.a. a slider panel), which is adapted for sliding movement between an open and a closed position over a slider panel opening 13. The sliding panel 20 may be transparent or partially opaque and, for example, may comprise glass, polycarbonate, and/or various combinations of these and other plastic materials. FIG. 1 is viewed from within a vehicle compartment 21, where, for example, driver and passenger seating (not shown) would be disposed. As indicated by the arrows below the lower edges 20a of the slider panel 20, the upper slider assembly 10a is to be installed in a vehicle body portion 30.

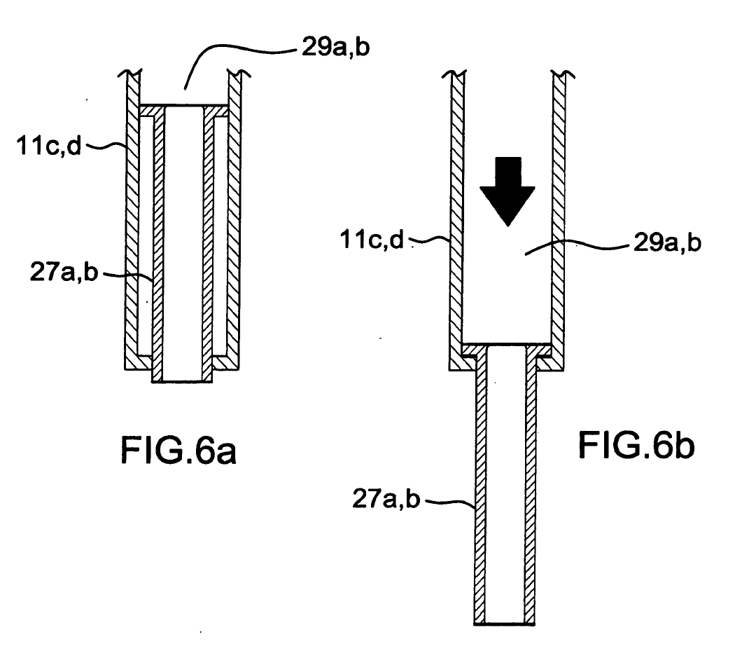

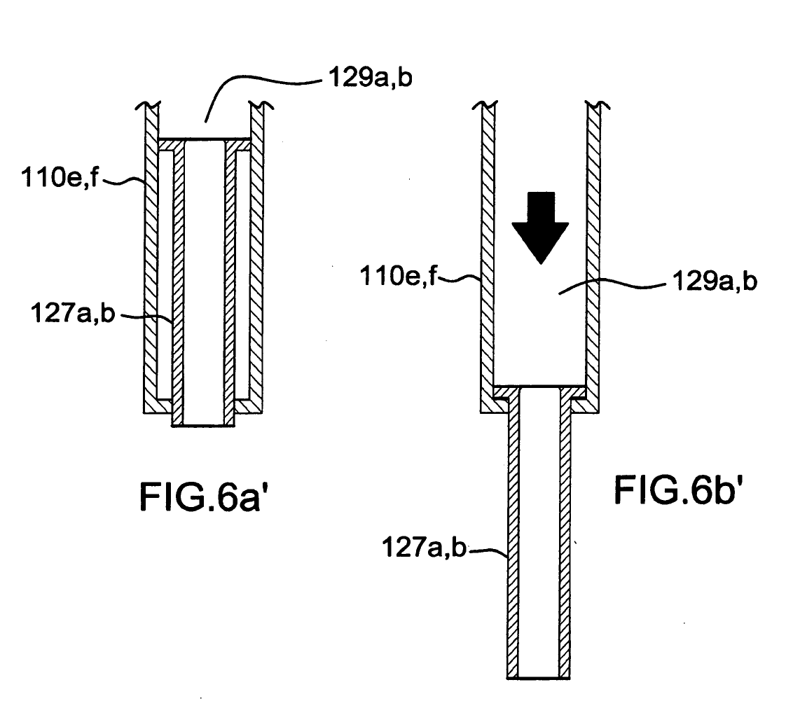

The present invention requires no horizontal beltline support member in an upper slider assembly frame member 10a (i.e., in the lower horizontal area across the width of the slider panel opening 13 between members 10b-b′) and, initially, vertical rails 27a,b may optionally be positioned, in a retracted/uninstalled state. For example, see FIG. 6a, which is a cross sectional cut away view in the direction of the 6a arrows of FIG. 1, of the vertical rails 27a,b in the retracted state. The retracted vertical rails 27a,b are positioned above the lower edge 20a of the slider panel 20.

As a result, installation of the upper slider assembly member 10a starts by urging the slider panel lower edge 20a to spread open vehicle body opening seals 17a,b that are respectively disposed on horizontal vehicle body opening edges 18a,b (a.k.a., horizontal vehicle body opening members 18a,b), which are separate from the upper slider assembly member 10a. The vehicle body opening seals 17a,b are in direct contact with the interior and the exterior surfaces of the slider panel 20. The upper slider frame assembly 10a comprises at least an upper horizontal header frame member 19 and additional peripheral frame members 10b-b′ and 11e-f disposed on remaining edges of fixed panels 11a,b. The upper frame assembly 10a is adapted to be secured within the vehicle body opening 16.

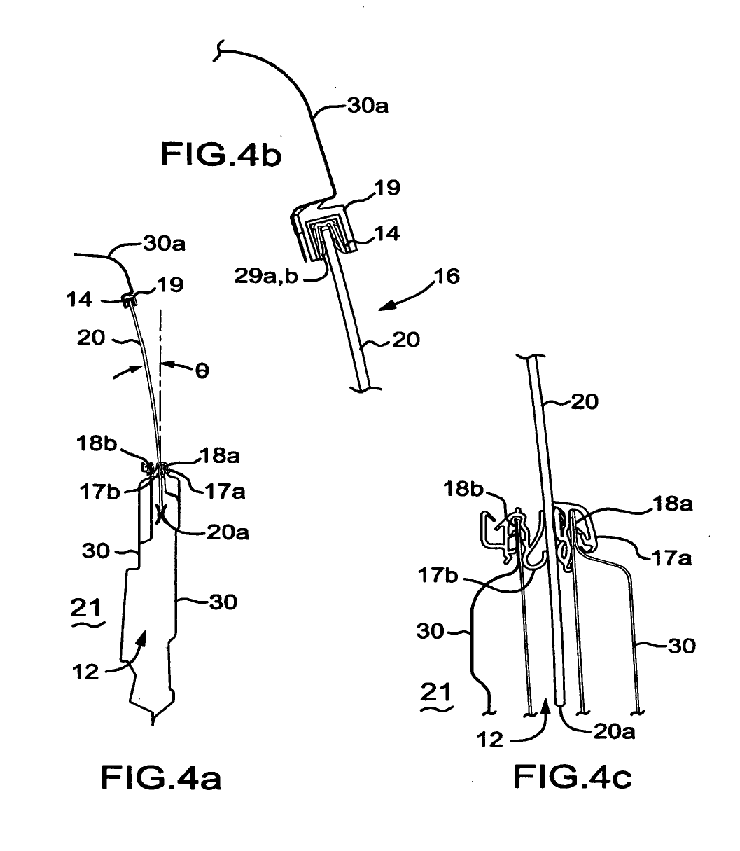

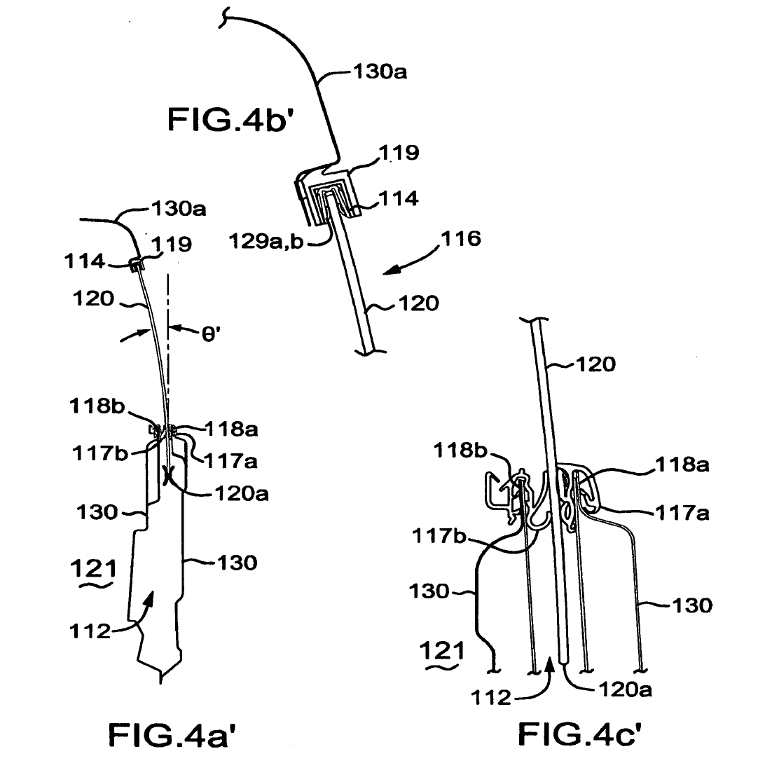

The fixed panels 11a,b may be transparent or partially opaque and, for example, may comprise glass, polyvinyl chloride, polycarbonate, and various combinations of these and other plastic materials. The vehicle body seals 17a,b are shown in FIGS. 4a,c in direct contact with, respectively, the exterior and interior surfaces 36,34 of the slider panel 20.

Cooperation between the sliding panel bottom edge 20a and the vehicle body seals 17a,b results in (if the vertical rails 27a,b are initially in the retracted/uninstalled state) the bottom edge 20a easily entering a vehicle body space 12 that is within the vehicle body portion 30. With the vertical rails 27a,b in the retracted state, insertion of the slider panel 20 can be attained with an angle of insertion θ (see FIG. 4a) that is greater than 10 degrees and is accomplished with minimal physical conflict between the upper slider assembly 10a and the upper vehicle body portion 30a.

This is not the case for conventional sliders that have rigidly extending vertical rails or if the vertical rails 27a,b are initially in the extended state (see, for example, FIG. 6b). Therefore, the above stated ease of installation may also be due in part to the vertical rails 27a,b not initially extending beyond the separate lower horizontal members 10b,b′ of the upper slider assembly 10a.

After insertion of the bottom edge 20a into the vehicle body space 12, the retracted vertical rails 27a,b may then easily be urged between the vehicle body seals 17a,b and into the vehicle body space 12 (see, for example, FIG. 6b where the vertical rail 27a or 27b is in the extended state). In the extended state, the vertical rails 27a,b remain aligned with their respective upper vertical channels 29a,b that may be disposed within respective division side frame members 11c,d that are disposed on interior edges 11g,h of fixed panels 11a,b. The vertical rails 27a,b and the vertical channels 29a,b are defined therein for selectively receiving a peripheral edge of the slider panel 20.

Subsequently, the extended vertical rails 27a,b can then be locked in place, for example, by way of mechanical locking pins (not shown) that could be common in the art, or the extended rails 27a,b can be locked in place by way of an installation of seals like the slider frame seals 14, which may be compression fitted into the rails 27a,b after the rails 27a,b are fully extended. The seals within the rails 27a,b may be co-extruded with the rails 27a,b as one piece.

In contrast, conventional partial drop vertical slider assemblies typically require rigidly affixed vertical division bars that extend beyond the lower edge to be inserted at a lesser angle (for example, approximately 10 degrees or less from an axially oriented centerline of a slider panel/vehicle body portion that is taken from the point of entry into the vehicle body space 12).

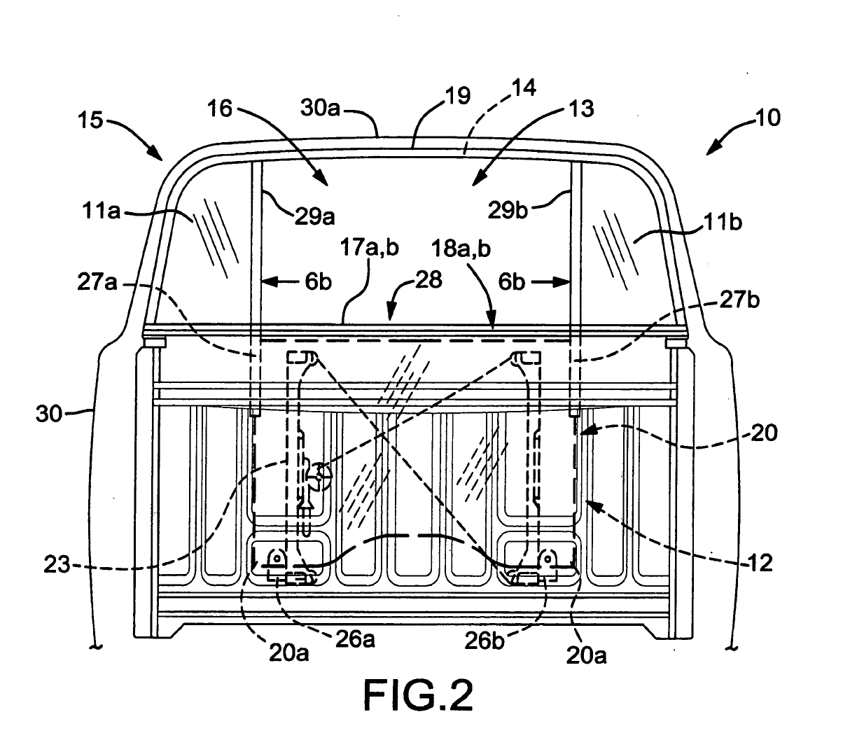

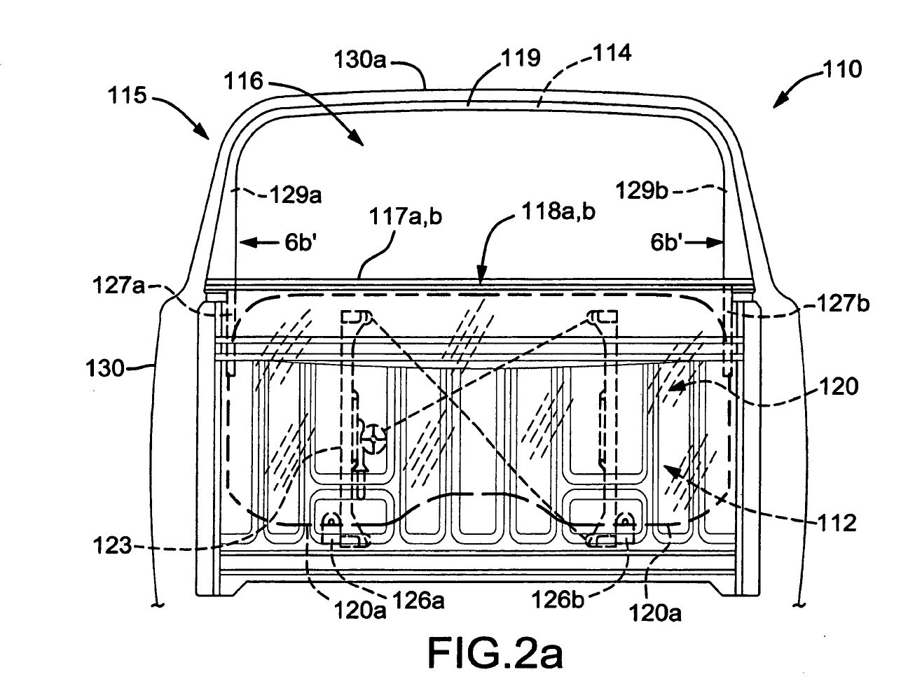

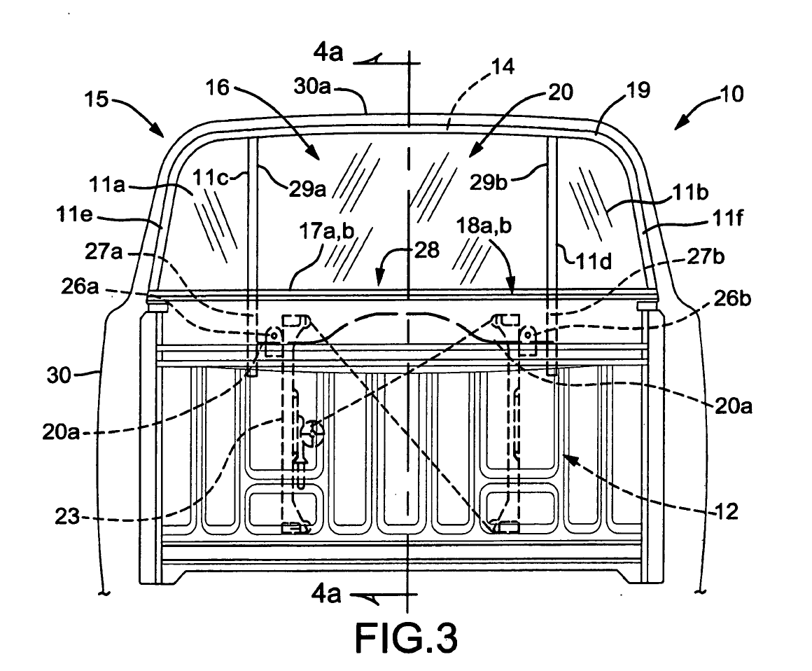

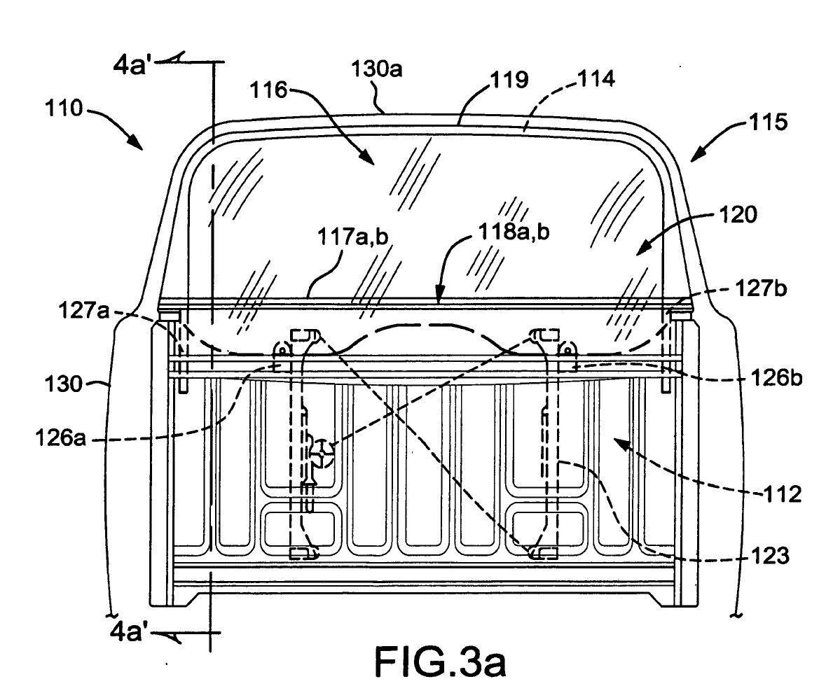

Thus, as illustrated in FIGS. 2 and 3, the extended vertical rails 27a,b and their respective fixed panel channels 29a,b cooperate to provide unencumbered entry of the slider panel 20 into the vehicle body space 12. Within the vehicle body space 12, the slider panel 20 can then be disposed on an electro-mechanical raising/lowering device which may be common in the art. For example, a powered slider drive interface 23, which comprises lifters 26a,b that are in intimate contact with the sliding panel bottom edge 20a, to electro-mechanically raise and lower the vertical vehicle sliding panel 20.

As depicted in FIG. 2, the slider panel 20 is completely disposed in the vehicle body space 12 (i.e., the fully lowered position) and positioned below a vehicle body opening 16, with the vertical rails 27a,b in their lowered/extended position. The vehicle body opening 16 is typically positioned behind seats (not shown) in the vehicle compartment 21 of, for example, a pick-up truck 15. As such, a panel frame comprised of the upper horizontal header member 19, the fixed panel vertical division side members 11c,d (see, for example, FIG. 1) that are disposed on the respective fixed panel edges 11g,h (see, for example, FIG. 3), and the horizontal vehicle body edges 18a,b abut one another to define the sliding panel opening 13 (i.e., the backlite opening).

Further advantages of the assembly 10 utilizing only the vehicle body opening edges 18a,b, with associated seals 17a,b as the lower horizontal member of the vertical slider assembly 10, are that only one set of lower horizontal opening edges 18a,b and seals 17a,b are required to provide the necessary dimensional tolerance, rigidity, and seal engagement. This compares to conventional slider assemblies, where the necessary dimensional tolerance, rigidity, and seal engagement for two sets of lower horizontal edges (i.e., the lower beltline support member of the slider assembly itself and the lower horizontal body edges at the sliding panel opening 13) must be provided. This area of any slider assembly is of particular concern, since, due in part to gravity, the lower horizontal edge of the slider assembly 10 is the area of the slider assembly 10 most prone to allow moisture to leak into the vehicle 15.

In addition to the vehicle body opening seals 17a,b, at the lower periphery of the vehicle body opening 16, at least one slider frame seal 14 is, typically, disposed on the remaining periphery of the vertical slider assembly 10 (i.e., the upper horizontal header member 19, the substantially vertical outer assembly members 11e,f, and the lower horizontal members 10b,b′ of respective fixed panels 11a,b).

Note that the two lower horizontal members 10b,b′ are separated by a gap 28 therebetween, which spans the entire horizontal width of the sliding panel opening 13, wherein the slider panel opening 13 is defined by the one or more frame members 11c,d, 19 and the vehicle body opening edges 18a,b that coincide with the horizontal gap 28 in the slider panel frame 10a, 10b,b′, 11e,f, 19.

Thus, this embodiment requires no lower horizontal beltline support member (that would be directly attached to the slider assembly 10) across the gap 28 at the sliding panel opening 13, as conventional slider assemblies do, and does not necessarily attain substantial rigidity from the upper slider assembly 10a alone. Instead, the present invention takes advantage of the rigidity provided by the vehicle body portion 30, by utilizing the horizontal vehicle body opening edges 18a,b, and attains at least a portion of its rigidity from the vehicle body portions 30, 30a, when the present invention is installed in the vehicle body opening 16.

FIG. 3 illustrates the vertical vehicle slider panel 20 being in the fully raised position, thus closing the sliding panel opening 13, where the vertical rails 27a,b are in their extended position, which may be a locked position or the rails 27a,b may have been initially formed as extending away from the lower horizontal members 10b,b′. FIG. 4a depicts a cut away view to the left of the line 4a-4a in FIG. 3, where the panel 20 is in the fully raised position. The panel 20 is shown seated in the slider frame seal 14 at the top of the slider assembly 10, and the panel 20 is shown cooperating with the vehicle body opening seals 17a,b at the bottom of the vehicle body opening 16.

Note that the seals 14 and 14a,b, as illustrated in the various figures throughout, may be separate items that are installed in the panel channels 29a,b, including internal channels of the vertical rails 27a,b. However, the seals 14 and 14a,b may be co-extruded as an intimate part of the seals' associated members, for example, items 10a,b,b′, 11c,d,e,f, 19, or 27a,b.

FIG. 4b illustrates the details of the top of FIG. 4a. FIG. 4c illustrates the details of the middle portion of FIG. 4a, where the vehicle horizontal body seals 17a,b (which may include flock, not shown) and the vehicle horizontal body opening edges 18a,b are detailed, which comprise the lower horizontal member of the sliding panel opening 13. The seals 17a,b provide the necessary sealing of the panel 20, so that moisture, dirt, and the like are prevented from entering the vehicle body space 12.

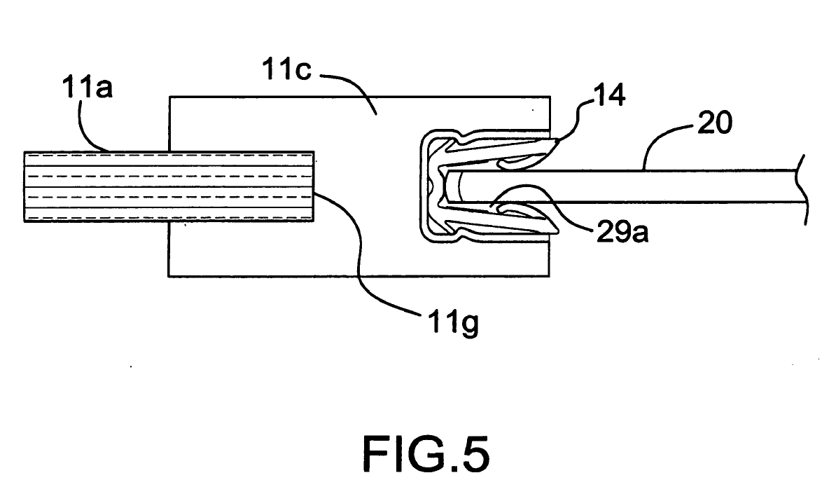

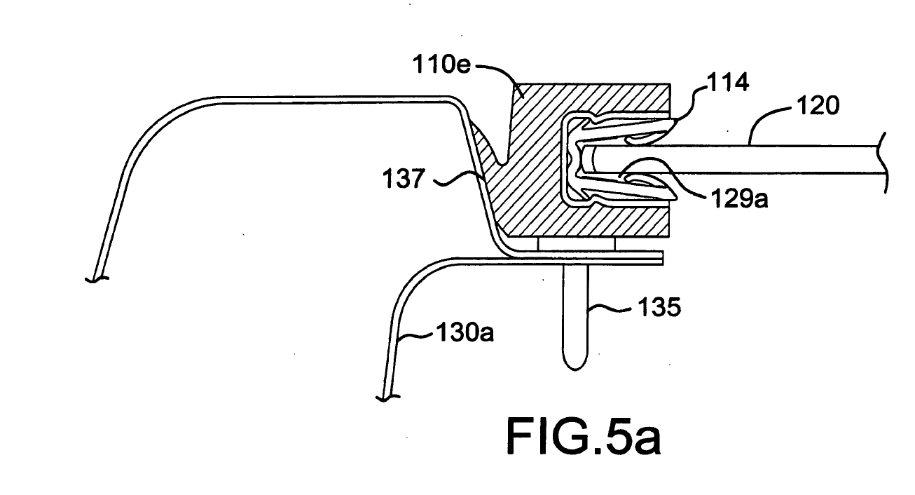

FIG. 5 illustrates a cut away view in the direction of the line 5-5 in FIG. 1, where the vertical left division side member 11c (note that the opposite side of the slider assembly 10, i.e., the vertical right division member 11d, would be constructed similarly while utilizing similar items 11b, 11h, 14b, and 29b) is disposed on a fixed panel edge 11g of the left fixed panel 11a by way of, for example, an adhesive (not shown) between the vertical left division side member 11c and the left fixed panel 11a, or molded, for example, in situ. The left slider division seal 14a, which is disposed in the left division side member 11c, seals out moisture, dirt, and the like from entering the vehicle compartment 21, and cooperates with the channels 29a for movement of the panel 20 that is shown disposed therein.

It is a discovery of the instant invention that, optionally, by initially providing the vertical rails 27a,b in the retracted position, unencumbered installation of the present invention slider assembly 10 results. This ease of installation of the present slider assembly 10 may be contrasted with the difficulties that arise in connection with the installation of conventional slider assemblies that comprise a lower beltline support member, a rigid framework, and/or rigid vertical track members that extend below the bottom of the conventional slider assemblies. These difficulties, associated with conventional slider assemblies, are in part a result of requiring careful maneuvering of the lower beltline support member and the rigid vertical track members into the vehicle body portions below the vehicle body opening.

In the present invention, better rigidity and sealing engagement is provided by taking advantage of the rigidity of the vehicle body instead of an added part (i.e., a framework that often is in addition to the frame of the slider assembly, a horizontal support member, or rigid vertical track members that extend into the vehicle body space). The present invention reduces a partial vertical slider provider's material, shipping, and assembly labor costs, requires less weight and space in shipping, requires less space within the vehicle to dispose the backlite, and additionally, provides better noise and moisture barriers for the backlite.

FIG. 1a illustrates another vehicle slider frame assembly embodied as a full drop vertical vehicle slider assembly 110. The full drop assembly 110 has a single sliding panel 120, which is adapted for sliding movement between an open and a closed position over a slider panel opening 113. FIG. 1a is viewed from within a vehicle compartment 121. As indicated by the arrows below horizontal frame members 110b,b′ of an upper slider assembly frame member 110a, the upper slider assembly member 110a, along with the single sliding panel 120, are to be installed in a vehicle body portion 130.

The full drop assembly 110 requires no horizontal beltline support member in the upper slider assembly member 110a and, initially (as shown), vertical rails 127a,b (the rails 127a,b being disposed on separate sides of the upper slider assembly member 11a and, respectively, above the horizontal frame members 110b,b′) may optionally be positioned, in a retracted/uninstalled state. For example, see FIG. 6a′, which is a cross sectional cut away view in the direction of the 6a′ arrows of FIG. 1a, of the vertical rails 127a,b in the retracted state. The retracted vertical rails 127a,b are positioned above the lower edge 120a of the slider panel 120.

As a result, installation of the upper slider assembly member 110a starts by urging the slider panel lower edge 120a to spread open vehicle body opening seals 117a,b that are respectively disposed on horizontal vehicle body opening edges 118a,b (a.k.a., horizontal vehicle body members 118a,b), which are separate from the upper slider assembly member 110a. The vehicle body opening seals 117a,b are in direct contact with the interior and the exterior surfaces of the slider panel 120.

The upper slider member 11a comprises side frame members 110e,f and an upper header frame member 119. FIGS. 4a′,c′ show the vehicle body seals 117a,b to be in direct contact with, respectively, the exterior and interior surfaces 136,134 of the slider panel 120. The upper frame slider member 110a and the horizontal frame members 110b,b′ are adapted to be secured within the vehicle body opening 116.

Cooperation between the sliding panel bottom edge 120a and the vehicle body seals 117a,b results, if the vertical rails 127a,b are optionally initially in the retracted/uninstalled state, in the bottom edge 120a easily entering a vehicle body space 112 that is within the vehicle body portion 130. With the vertical rails 127a,b in the retracted state, insertion of the slider panel 120 is attained with an angle of insertion θ′ (see FIG. 4a′) that is, for example, greater than 10 degrees and is accomplished with minimal physical conflict between the upper slider member 110a and the upper vehicle body portion 130a.

This is not the case for conventional sliders that have rigidly extending vertical rails or if the vertical rails 127a,b are positioned initially in the extended state. Therefore, the above stated ease of installation may also be due in part to the vertical rails 127a,b not initially rigidly extending beyond the bottom edges 110b,b′ of the upper slider member 110a.

After insertion of the bottom edge 120a into the vehicle body space 112, the retracted vertical rails 127a,b may then easily be urged between the vehicle body seals 117a,b and into the vehicle body space 112 (see, for example, FIG. 6b′ which is a cross sectional cut away view in the direction of the 6b′ arrows of FIG. 2a of the vertical rails 127a,b in the extended state). In the extended state, the vertical rails 127a,b remain aligned with their respective upper vertical channels 129a,b that may be disposed throughout respective upper slider assembly side members 110e,f. The vertical rails 127a,b and channels 129a,b are defined therein for selectively receiving a peripheral edge of the slider panel 120.

Subsequently, the extended vertical rails 127a,b can then be locked in place, for example, by way of a mechanical locking pin (not shown) that could be common in the art, or the extended rails 127a,b can be locked in place by way of an installation of a seal like the slider frame seal 114 that may be compression fitted into the rails 127a,b, after the rails 127a,b are fully extended. The seals 114 within the rails 127a,b may be co-extruded with the rails 127a,b as one piece.

In contrast, conventional vertical slider assemblies typically require rigidly affixed vertical bars that extend beyond the slider assembly lower edge to be inserted at a tighter angle (for example, less than 10 degrees from an axially oriented centerline of a slider panel/vehicle body portion that is taken from the point of entry into the vehicle space 112).

Thus, as illustrated in FIGS. 2a and 3a, in the present invention, the extended vertical rails 127a,b and their respective panel channels 129a,b cooperate to provide easy entry of the slider panel 120 into the vehicle body space 112. Within the vehicle body space 112, the slider panel 120 can then be disposed on an electro-mechanical raising/lowering device. For example, a powered slider drive interface 123 (which may be common in the art), that comprises lifters 126a,b that are in intimate contact with the sliding panel bottom edge 120a, to electro-mechanically raise and lower the vertical vehicle sliding panel 120.

As depicted in FIG. 2a, the slider panel 120 is completely disposed in the vehicle body space 112 (i.e., the fully lowered position) and positioned below a vehicle body opening 116, with the vertical rails 127a,b in their lowered/extended position. The vehicle body opening 116 is typically positioned behind seats (not shown) in the vehicle compartment 121 of, for example, a pick-up truck 115. As such, the upper horizontal header member 119, the upper slider assembly side members 110e,f, and the horizontal vehicle body opening edges 118a,b abut one another to form the sliding panel opening 113 (i.e., the backlite opening, as shown, for example, in FIG. 1a).

Further advantages of the assembly 110 utilizing only the vehicle body opening edges 118a,b, with associated seals 117a,b, as the lower horizontal member of the vertical slider assembly 110, are that only one set of lower horizontal vehicle opening edges 118a,b and seals 117a,b are required to provide the necessary dimensional tolerance, rigidity, and seal engagement. This compares to conventional slider assemblies, where the necessary dimensional tolerance, rigidity, and seal engagement for two sets of lower horizontal edges (i.e., the lower beltline support member of the slider assembly itself and the lower horizontal body edges) must be provided. This area of any slider assembly is of particular concern, since, due in part to gravity, the lower horizontal edge of the slider assembly 110 is, typically, the area of the slider assembly 110 most prone to allow moisture to leak into the vehicle 115.

In addition to the vehicle body opening seals 117a,b at the lower periphery of the vehicle body opening 116, at least one slider frame seal 114 is, typically, disposed on the remaining periphery of the slider assembly 110 (i.e., the upper horizontal header member 119, the substantially vertical outer assembly members 110e,f, and the upper slider assembly bottom edges 110b,b′).

Note that the two upper slider assembly bottom edges 110b,b′ are separated by a gap 128 therebetween, which spans the entire horizontal width of the sliding panel opening 113, wherein the slider panel opening 113 is defined by the one or more frame members and the vehicle body opening edges 118a,b that coincide with the horizontal gap 128 in the slider panel frame 110a, 10b,b, 110e,f, 119.

Thus, the assembly 110 requires no lower horizontal beltline support member, as conventional slider assemblies do, and the assembly 110 does not necessarily attain substantial rigidity from the upper slider member 110a alone. Instead, the present invention takes advantage of the rigidity provided by the vehicle body, by utilizing the horizontal vehicle body opening edges 118a,b, and attains at least a portion of its rigidity from the vehicle body portions 130, 130a, when the assembly 110 is installed in the vehicle body opening 116.

FIG. 3a illustrates the vertical vehicle slider assembly 110 being in the fully raised position, thus closing the sliding panel opening 113, where the vertical rails 127a,b are in their extended position, which may be a locked position or the rails 127a,b may have been initially formed as extending away from the bottom edges 110b,b′.

FIG. 4a′ depicts a cut away view to the left of the line 4a′-4a′ in FIG. 3a, where the panel 120 is in the fully raised position. The panel 120 is shown seated in the slider frame seal 114 at the top of the slider assembly 110, and the panel 120 is shown cooperating with the vehicle body opening seals 117a,b at the bottom of the vehicle body opening 116 to seal out moisture, noise, dirt, and the like.

Note that the seal 114, as illustrated in the various figures, may be a separate item that is installed in the panel channels 129a,b, including (although not shown) internal channels of the vertical rails 127a,b. However, the seal 114 may be co-extruded as an intimate part of its associated members, for example, items 110a,b,b′,e,f, 119, or 127a,b.

FIG. 4b′ illustrates the details of the top of FIG. 4a′. FIG. 4c′ illustrates the details of the middle portion of FIG. 4a′, where the vehicle horizontal body seals 117a,b (which may include flock, not shown) and the vehicle horizontal body opening edges 118a,b are detailed, which comprise the lower horizontal member of the sliding panel opening 113. The seals 117a,b provide the necessary sealing of the panel 120, so that moisture, dirt, and the like are prevented from entering the vehicle body space 112.

FIG. 5a illustrates a cut away view in the direction of the line 5′-5′ in FIG. 1a, where the substantially vertical left outer assembly member 110e (note that the opposite side of the slider assembly 110, i.e., the substantially vertical right outer assembly member 110f, would be constructed similarly while utilizing similar items 114, 130, 135, and 137) is disposed on the upper vehicle body portion 130a by way of, for example, an adhesive 137 therebetween, along with a stud 135. The slider frame seal 114, which is disposed in the outer side assembly member 110e, seals out moisture, dirt, and the like from entering, for example, the vehicle compartment 121 or the vehicle body space 112, and cooperates with the channels 129a for movement of the panel 120 that is shown disposed therein.

It is a discovery of the instant invention that, optionally, by initially providing the vertical rails 127a,b in the retracted position, unencumbered installation of the present invention slider assembly 110 results. This ease of installation of the instant slider assembly may be contrasted with the difficulties that arise in connection with the installation of conventional slider assemblies that comprise a lower beltline support member, a rigid framework, and/or rigid vertical track members that extend below the bottom of the conventional slider assemblies. These difficulties, associated with conventional slider assemblies, are in part a result of requiring careful maneuvering of the lower beltline support member and the rigid vertical track members into the vehicle body portions below the vehicle body opening.

Also, the single panel 120 is disposed over the entire vehicle body opening 116, where no edges, division bars, mullions, pillars, fixed panels, or the like are disposed that could impair the view through the opening when the single panel 120 is in the fully raised position or other positions. Thus, the present invention may require no seals to be disposed on the single panel 120, no framework to hold the single panel 120, and no need to have any fixed panels.

In the assembly 110, better rigidity and sealing engagement is provided by taking advantage of the rigidity of the vehicle body, instead of an added part (e.g., a framework that is in addition to the frame of the slider assembly, a horizontal support member, or rigid vertical track members that extend into the vehicle body space). The assembly 110 reduces a slider provider's material, shipping, and assembly labor costs, requires less weight and space in shipping, requires less space within the vehicle to dispose the backlite, and additionally, provides better noise and moisture barriers for the backlite.

It is to be understood that the patent drawings are not intended to define precise proportions of the elements of the invention but that the patent drawings are intended to be utilized in conjunction with the rest of the specification. Unless expressly specified to the contrary, it should also be understood that the illustrated differences between various elements of the invention, which may be in fractions of a unit of measurement, are not intended to be utilized to precisely measure those differences between the various elements.

In accordance with the provisions of the patent statutes, the principles and modes of operation of this invention have been described and illustrated in its preferred embodiments. However, it must be understood that the invention may be practiced otherwise than as specifically explained and illustrated without departing from its spirit or scope.

1. A vehicle slider assembly (10) (110), comprising:
at least one vertical slider panel (20) (120) adapted for sliding movement between a closed position and an open position over a slider panel opening (13) (113), and a slider panel frame comprised of one or more frame members (19) (11c,d) (119) (110e,f), the improvement comprising:
the slider panel frame (11c,d) (110e,f) having a first and a second end, and a horizontal gap (28) (128) therebetween, the slider panel frame (11c,d) (110a) adapted to be secured within a vehicle body opening (16) (116) and having a channel (29a,b) (129a,b) defined therein for selectively receiving a peripheral edge of the slider panel (20) (120);
wherein the slider panel opening (13) (113) is defined by the one or more frame members (19) (11c,d) (119) (110e,f) and a vehicle body opening edge (18a,b) (118a,b) that coincides with the horizontal gap (28) (128) in the slider panel frame (11c,d) (110e,f).

2. The vehicle slider assembly (10) of claim 1, wherein the vertical slider panel (20) comprises a transparent material selected from the group consisting of glass, polyvinyl chloride (PVC), and polycarbonate.

3. A vehicle slider assembly (10) as defined by claim 1, further comprising at least two fixed panels (11a,b), wherein the one or more frame members comprise a header member (19) and side division members (11c,d) disposed on separate fixed panel edges (11g,h).

4. The vehicle slider assembly (10) of claim 3, wherein the fixed panels (11a,b) comprise a transparent material selected from the group consisting of glass, polyvinyl chloride (PVC), and polycarbonate.

5. The vertical vehicle slider assembly (10) of claim 2, wherein the vehicle body opening edge (18a,b) comprises seals (17a,b) in direct contact with the interior and the exterior surfaces of the slider panel (20).

6. The vertical vehicle slider assembly (10) of claim 3, wherein each side member (11c,d) comprises a vertical rail (27a,b) having a retracted position and an extended position.

7. The vertical vehicle slider assembly (10) of claim 6, wherein each vertical rail (27a,b) is extendable into a vehicle body space (12).

8. The vertical vehicle slider assembly (10) of claim 7, wherein prior to installation of the vertical vehicle slider assembly (10) into the vehicle body opening (16) (116) the vertical rails (27a,b) are retracted, and, after installation has begun, the vertical rails are extended, thereby allowing unencumbered installation of the vertical vehicle slider assembly (10) into the vehicle body opening (16).

9. The vertical vehicle slider assembly (10) of claim 3, further comprising seals (14) (14a,b) disposed in the header member (19) and the side members (11e,f) (11c,d).

10. The vertical vehicle slider assembly (10) of claim 3, further comprising a powered slider drive interface (23) for raising and lowering the slider panel (20).

11. A pick-up truck (15), comprising the vertical vehicle slider assembly (10) of claim 3.

12. A vertical vehicle slider assembly (110), comprising:
a vehicle slider assembly (110) according to claim 1, the vehicle slider assembly (110) disposed in the vehicle body opening (116); and
a single slider panel (120);
wherein, the single slider panel (120) covers the entirety of the vehicle body opening (116) when the single slider panel (120) is in a fully raised position, thus providing unimpaired viewing through the vehicle body opening (116).

13. The vertical vehicle slider assembly (110) of claim 12, wherein the vertical slider panel (120) comprises transparent material selected from the group consisting of glass, polyvinyl chloride (PVC), and polycarbonate.

14. The vertical vehicle slider assembly (110) of claim 12, wherein the vehicle body opening edge (118a,b) comprises seals (117a,b) in direct contact with the interior and the exterior surfaces of the slider panel (120).

15. The vertical vehicle slider assembly (110) of claim 12, further comprising two vertical rails (127a,b), each vertical rail (127a,b) having a retracted position and an extended position and being disposed on separate sides of an upper slider assembly frame member (119).

16. The vertical vehicle slider assembly (110) of claim 15, wherein each vertical rail (127a,b) is extendable into a vehicle body space (112).

17. The vertical vehicle slider assembly (110) of claim 16, wherein prior to installation of the vertical vehicle slider assembly (110) into a vehicle body opening (116) the vertical rails (127a,b) are retracted, and, after installation has begun, the vertical rails (127a,b) are extended, thereby allowing unencumbered installation of the assembly (110) into the vehicle body opening (116).

18. The vertical vehicle slider assembly (110) of claim 12, further comprising a powered slider drive interface (123) for raising and lowering the slider panel (120).

19. A pick-up truck (115), comprising the vertical vehicle slider assembly (110) of claim 12.
